(19) United States
(12) Patent Application Publication
(10) Pub. No.: US 2009/0214731 A1
(43) Pub. Date: Aug. 27, 2009

(54) Batch Processing of Animal-Source Food Product

(75) Inventors: Aaron Kelly Ormond, Hanford, CA (US); Cesar Alfonso Montano, Hanford, CA (US); Nicholas Del Hofeldt, Pocatello, ID (US)

Correspondence Address: FENWICK & WEST LLP, SILICON VALLEY CENTER, 801 CALIFORNIA STREET, MOUNTAIN VIEW, CA, 94041, US

(73) Assignee: GLOBAL FOOD TECHNOLOGIES, Hanford, CA (US)

(21) Appl. No.: 12/035,589

(22) Filed: Feb. 22, 2008

(51) Int. Cl. A23L 3/3454

(52) U.S. Cl. 426/326; 426/332; 426/327

(57) ABSTRACT

Apparatus and method for processing seafood, meat, and poultry includes a pre-rinse spraying using water solutions containing an antimicrobial agent, and then subjection to pressurized water solution at pressures greater than atmospheric pressure for a selected period to reduce microbial flora on the product prior to freezing or other packaging.

### RELATED APPLICATION

The subject matter of this application relates to the subject matter of application Ser. No. ______, entitled “Continuous Processing of Animal-Source Food Product,” filed on even date herewith, which subject matter is incorporated herein in the entirety by this reference hereto.

### FIELD OF THE INVENTION

This invention relates to equipment and processes for processing seafood, poultry, and other meats to reduce microbial flora on the product and promote extension of shelf life.

### BACKGROUND OF THE INVENTION

Seafood, poultry, and other meat products are considered at-risk foods for carrying food-borne pathogens and other spoilage microorganisms. Due to the high volume processing and the ubiquitous nature of microbes, they are often present in the end-consumer food supply and pose a significant risk to the consumer. Such products are often transported and sold fresh, without ever undergoing a freeze process, leaving them at high risk for contamination by food-borne pathogens. However, due to the inherent properties of some microorganisms, such as Listeria, frozen products are not necessarily risk free either and additional control measures in the processing and packaging phases of both fresh and frozen production is warranted.

Prokaryotic cell structures (bacteria) have many common characteristics that can be targeted during processing to reduce microbial loads on consumable products. The cells contain a glycopeptide cell wall and phospholipid bilayer defining the cell membrane of the organism. Bacterial cell membranes are the metabolic site of action for the organism and contain numerous integral proteins that facilitate life processes including proliferation of the organism. The structural integrity of cell membranes is maintained by non-covalent hydrophobic interactions between the fatty acid tails and ionic and hydrogen bonds between the polar head groups of the membrane phospholipids. Changes in pH have large effects on ionic and hydrogen bonds. At low pH, the influx of H+ can protonate groups that are normally ionized, masking the negative charge, and eliminating the charged partner for both ionic and hydrogen bonds. High pH has the opposite effect of stripping H+ from ionic or hydrogen bonding partners and producing a negative charge that had not previously been present. Polar organic solvents are particularly effective at dissolving membranes because the phospholipids can form hydrophobic, ionic and hydrogen bonds with the solvent, rather than with each other.

The integrity of the plasma or cytoplasmic membranes of eukaryotic and prokaryotic cells is essential for cell viability, and organic solvents, such as a peroxygen compound, can disrupt the hydrophobic bonds between the fatty acids of the lipid bilayers and dissolve the membranes. Additionally, less harsh conditions, such as altering the pH or temperature of the environment can kill cells due to their effects on membrane protein structure. Because protein secondary, tertiary, and quaternary structures are highly dependent on many non-covalent but highly specific ionic, hydrogen, and hydrophobic bonds between amino acids, agents that disrupt these bonds and denature membrane proteins can be lethal to the microorganism. For example, acidic pH, produced by the addition of a peroxygen compound, protonates amino acids with negatively charged R groups, like aspartate and glutamate. If an ionic bond between an aspartate residue and a positively charged amino acid like lysine is essential for protein structure, this bonding will be disrupted at low pH, and the protein will not function. Hydrogen bonds are similarly disrupted by changes in pH. Therefore, denaturation essentially kills the microorganism through the continued manipulations of its environment.

Cell walls are a structural component of bacterial cells that define morphology and provide protection, but restrict the ability of the cells to expand because of the rigid nature. The alteration of solute concentrations due to changes in pressure, and the disruption of membrane integrity due to variations in temperature and pH create an exterior environment that encourages diffusion of solutes into the bacterial cell, causing it to swell and increase pressure on the cell wall until it ruptures.

### SUMMARY OF INVENTION

In accordance with the present invention, it has been determined that alterations in pH, temperature, pressure, flow rates, conveyance speeds and spray parameters reduce microbial loads on seafood, poultry, and other meat products presumably by disrupting bonding properties and destroying bacterial membranes. In accordance with the present invention, seafood, poultry and other meat products are pre-processed, for example, into unit portions, fillets or steaks, and are loaded onto trays to be conveyed through a defined spray-wash apparatus that uses water containing a selected concentration of antimicrobial agent. Trays are then removed from the spray apparatus and loaded into a pressure vessel. The pressure vessel is closed and filled with water containing a selected concentration of antimicrobial agent, and the trays of product are subjected to pressure levels greater than atmospheric pressure. Once the pressure cycle is completed to specification, the vessel is drained of fluid, and the trays are removed from the vessel for packaging to be distributed as fresh product or moved into freezing line for freeze packaging. The processes of the present invention result in reduced harmful microbial loads on the product, while maintaining organoleptic and nutritional qualities of the product.

### BRIEF DESCRIPTION OF THE DRAWINGS

FIGS. 1A, 1B comprise a plan view of a processing system in accordance with the present invention; and

FIG. 2 is a perspective view of a processing chamber in the system of FIG. 1.

### DETAILED DESCRIPTION OF THE INVENTION

Seafood, poultry, and other meat products provide a nutritious food source for microorganisms that can cause illness or accelerate spoilage of the product. Large-scale food production, in turn, inherently increases the likelihood of cross-contaminating events during processing. Proactive preventative control measures are actively sought to control these issues in the food industry. In accordance with an embodiment of the present invention, operation of a spray washer, conveyor, and pressure vessel reduce microbial loads on animal-source food products through the stages of processing just prior to packaging of individual portions.

Ambient temperature directly correlates with microbial growth and hence is a parameter that is controlled in the operating environment of the food-processing area to within a range of about 34-38 degrees Fahrenheit to reduce growth rates of most mesophilic organisms.

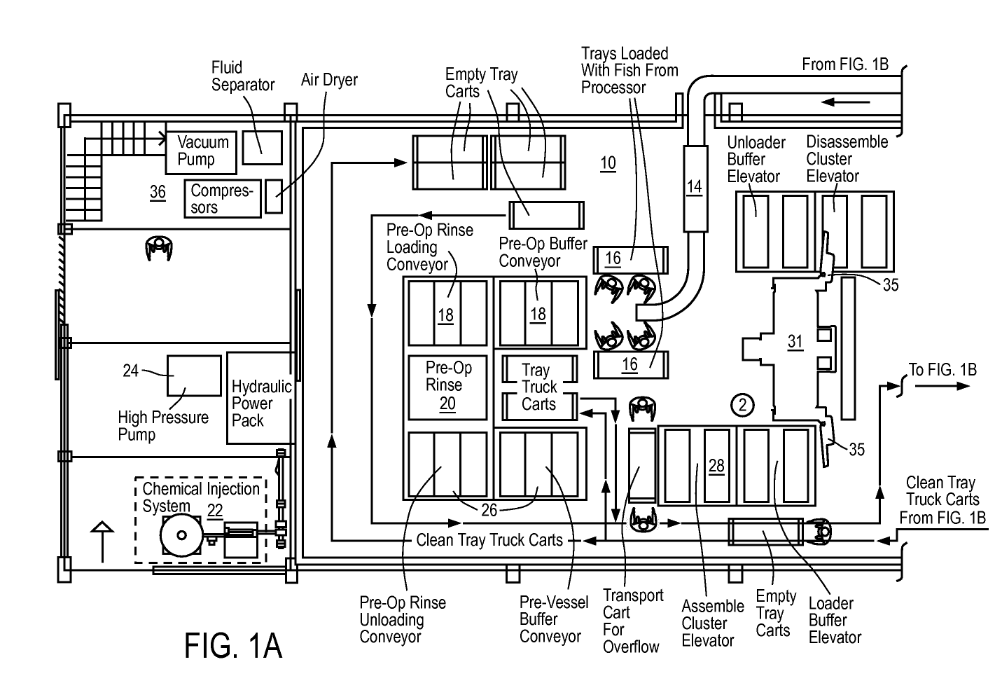

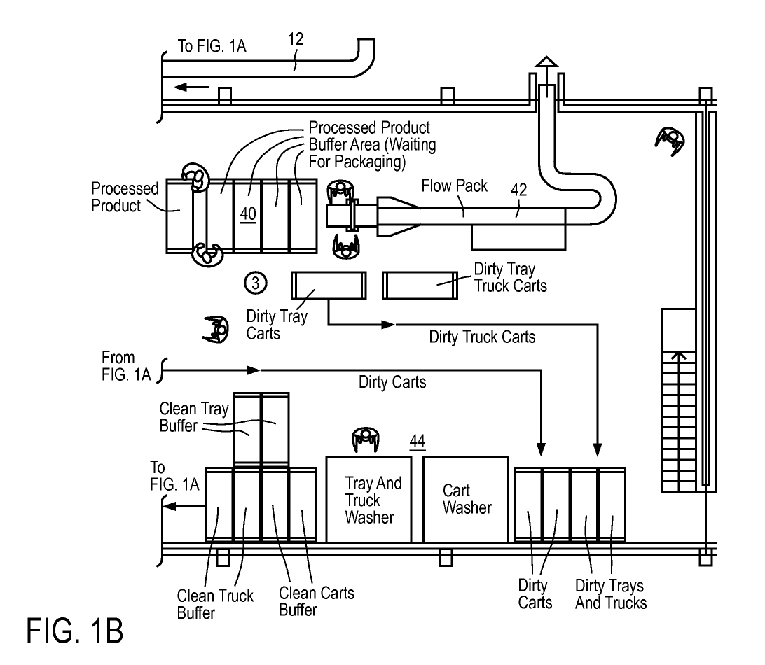

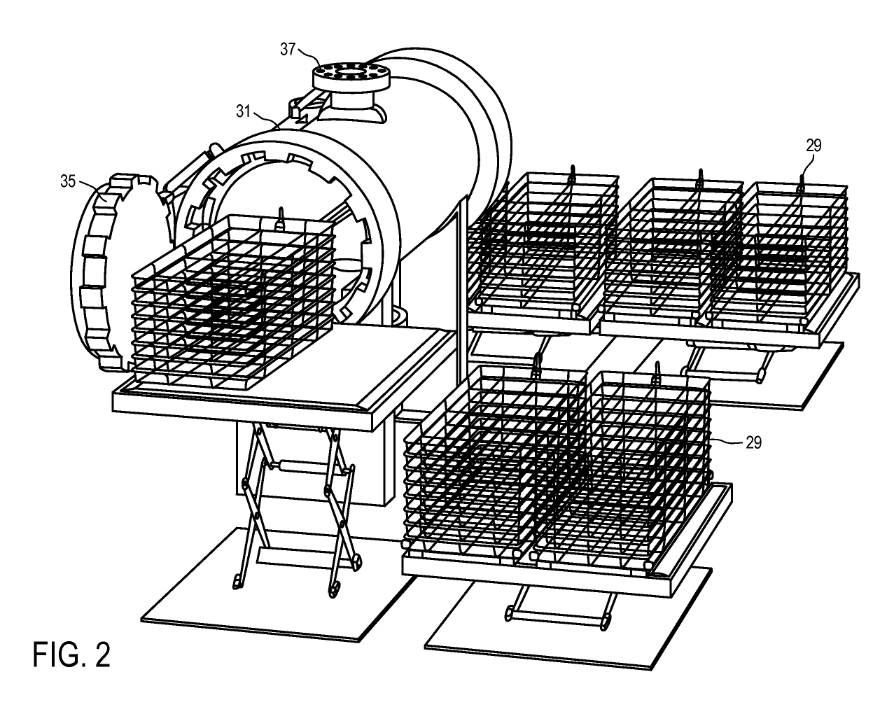

Referring now to FIGS. 1A, 1B, there is shown one embodiment of a processing system in accordance with the present invention. Animal source food products that are derived from fish or poultry or meat sources are pre-processed outside of the facility 10 (not shown) to form unit portions, such as fish fillets, chicken parts, meat steaks, and the like, that enter the facility along transport system 12 such as a conveyor. The unit portions are weighed on station 14. Beyond the station 14, the unit portions are loaded onto trays 16 that contain porous compartments. These trays 29, as illustrated in FIG. 2, are formed of bio inert material such as stainless steel or bio compatible plastic material, and may include wheels of similar material mounted on the bottoms to facilitate convenient manual rolling along processing surfaces.

The trays, loaded with unit portions are transferred to a conveyor or other transport system 18 for processing through one or more spraying facilities station 20 using a chilled water solution containing an antimicrobial agent. Spraying facilities use a water solution that is chilled to a temperature in the range above freezing and not greater than about 41° F. Such chilling operation is accomplished using refrigeration apparatus (not shown) disposed outside the processing facility 10.

In addition, the chilled water contains an antimicrobial agent in solution at a concentration of about 50 to about 150 parts per million (ppm), as introduced into the spray water via a chemical injection system 22 disposed outside the processing facility 10. The antimicrobial agent may be a peroxygen compound such as peracetic acid in the specified concentration that may be recovered, replenished and recycled among the spray station 20 using conventional pumps, filters and chemical injectors 22 in order to maintain concentration of antimicrobial agent within the specified range for maximally efficient and effective spray operation 20. High-pressure pumps 24 suitable for supplying the chilled water solution to the spray station 20 may be disposed outside of the processing facility 10.

Trays 29 loaded with unit portion of the food product are transferred to a conveyor or other transportation system from stations 18 to the spray system 20 using chilled water containing an antimicrobial agent within the specified range of concentration.

The trays 29 of sprayed unit portions that emerge from the spray system 20 are then transferred along conveyors 26 to an assembly station 28 at which a plural number of trays 29 containing unit portions of the food product are stacked or otherwise assembled into clusters of multiple trays for transfer into the pressure chamber 31, as illustrated in FIG. 2.

The chamber 31 includes ingress and egress end caps that may be conveniently opened hydraulically to orientations greater than 90° from the closed positions to facilitate loading and unloading of clusters of stacked trays 29. In operation, the clusters of trays are loaded into the chamber 31 and the end caps 35 are closed and locked tight into pressure-sealing engagement with the chamber 31. The chamber is then filled with a chilled water solution containing an antimicrobial agent within the specified range of concentration, and attached vents 37 and outlet valves are closed to seal the chamber 31 for filling with the specific water solution, at a temperature not greater than about 41° F., and pressurization. Once the chamber 31 is filled sufficiently to cover all stacked trays 29, the internal pressure is then rapidly increased within about 1 to about 90 seconds to various maximum pressure levels, depending upon the particular food product, within the range from about 420 to about 1300 pounds per square inch (psi) above atmospheric pressure. Elevated pressure may be maintained within the chamber 31 for a selected dwell period not exceeding about 60 seconds, depending in duration upon the particular food product, or may be vented through a controlled valve 37 in an upper portion of the chamber 31 to reduce the pressure rapidly down to atmospheric level within an interval ranging from about 10 to about 90 seconds. Pressurization equipment and hydraulic pumps (to operate the end caps 35) 36 may be disposed outside the processing facility 10.

Following completion of the pressurization cycle, the chamber 31 is drained through a controlled valve in the lower portion of the chamber 31, and the end caps 35 may be opened fully to unload 38 the clusters of stacked trays of pressure-treated unit portions, and to load the clusters of stacked trays 28 awaiting pressure treatment.

Trays of unit portions may be disassembled from the cluster or stacked configurations and individually positioned at station 40 for drip drying of excess water solution from the surfaces of the unit portions prior to transfer thereof to a packaging apparatus 42 to final packaging facilities (not shown) for freezing or fresh-iced or unfrozen sealed packaging of the processed unit portions.

Trays once used at the various processing stages previously described are then washed and sanitized 44 for return to the initial loading stations 16 where incoming unit portions of the food product are loaded onto the trays. The processing facility 10 incorporating the equipment in direct contact with the food products is operated at reduced temperature of about 41° F., and relies upon HEPA-filtered air circulated within the facility 10 to maintain a high-level sanitary environment for the processing of the unit portions of food product.

It should be noted in the processing system of FIGS. 1A, 1B and the perspective view of FIG. 2 that the animal-source food product is prepared along a trimming/finishing line as unit portions (i.e. may be filleting line for salmon, trimming for poultry breasts, etc.) for convenient bulk handling, and that the unit portions are loaded into trays 29 dimensioned to fit within the pressure vessel 31. Stacks of trays 29 in layers are loaded with unit portions of the product that are thus fully exposed to allow for perfusion of water and adequate later drainage of all processing water. The trays 29 may be formed of stainless steel, UHMW (ultra high molecular weight polyethylene, a plastic) or other food-grade and anticorrosive materials. These product trays 29 are loaded onto conveyor apparatus that conveys the trays to spray-wash apparatus 18. Portable water is chilled to an operating temperature between 35-41 Fahrenheit and is combined with a peroxygen antimicrobial agent in a concentration of the antimicrobial agent of about 50-150 ppm for spray washing and pressure application to the unit portions being processed.

Spray wash apparatus with associated nozzles oriented above the trays supply the process water containing the peroxygen agent at a pressure of about 10-30 psi to form an effective spray pattern and droplet size of process water suitable for impacting and coating the unit portions of product. The trays of product are conveyed at a rate of about 7 ft/min on a food-grade conveyor beneath a series of, for example, 5 spray bars that all receive the same process water at specified flow rates, water temperature, and antimicrobial concentrations. Of course, individual spray bars in the series may operate with different spray parameters and characteristics as may be operationally effective to materially reduce microbial contaminants on different products being processed. Oxidation interactions of the peroxygen compound on the product impacted by droplet size, pattern and pressure, coat the product to remove quantifiable portions of microbial flora present on the product and remove adherent debris prior to treatment in the pressure vessel 31. The rate of conveyance of trays determines dwell time beneath each spray apparatus and the associated exposure time to process water (typically about 43 seconds beneath each spray apparatus), as well as impulse force of spray droplets on the product.

Trays 29 of sprayed and rinsed product are stacked into cluster formation, as shown in FIG. 2, for loading into the pressure vessel 31. Each cluster of trays includes a tray truck that may be supported on food-grade wheels or skids to facilitate rolling and/or sliding along loading pallets and rails in the pressure vessel 31. Cylindrical design of the pressure vessel and tray size are optimized to effect maximum capacity processing per pressure cycle. Vessel construction is ASME certified to withstand processing pressures up to about 1500 psi and is constructed of stainless steel with particular interior surface finish to eliminate pocking or other structural harbors for microbial accumulation. Vessel interior includes two stainless steel rails along the bottom portion to support clusters of trays within the vessel.

Each pressure vessel 31 is operated in conjunction with a high pressure fluid pump capable of pressurizing the vessel, a hydraulic system for filling and draining the vessel, and a chiller system. Vessel 31 is of cylindrical design with end caps 35 that are capable of sealing the vessel 31 and that are mounted to open by an angle greater than 90 degree perpendicular to the closed position. A vent with associated valves 37 capable of operating at pressures up to 1500 psi are located on the upper surface of the vessel along with a pressure input line and associated valve in a line connected to a pressure system. A drain port and valve are located in the bottom of the vessel to drain process water from the vessel at the end of a pressure cycle, capable of draining the pressure vessel in approximately 60 seconds. Similarly, the fill line connecting pumps to the vessel 31 allow for filling of the vessel within about 90 seconds.

Product in trays received from the spray apparatus 20 and staged into clusters are loaded into the ingress end of the pressure vessel 31 and are positioned therein via tray wheels/skids in tray rails within the vessel. Clusters are slid fully into vessel allowing for closure of the end caps 35 to seal the vessel. Process water including an antimicrobial agent at selected antimicrobial concentration and at reduced temperature is transported from the chemical injection system 22 to the in-feed water line and associated input port of the vessel 31 to fill the vessel substantially to full volume. Process water continues to pass through the in-feed line until the fill process is completed, and then all valves are closed and the ancillary pressure system 24 is activated to ramp up the internal pressure within the vessel 31 above atmospheric pressure to a selected value of about 420-1300 psi in about 10-50 seconds. The pressure level and ramp-up parameters may vary according to the product being processed. Dwell time at the maximum pressure level is held for about 0-60 seconds (specific to product). Subsequently, vent valve 37 is opened and then the drain valve is opened to drain the vessel in about 60 seconds. Upon complete evacuation of process water, the end caps 35 are moved to open positions to permit removal of tray cluster containing processed product and to facilitate loading of subsequent tray clusters of product. The tray clusters removed from the vessel 31 are positioned to allow the product to drip dry or be forced-air dried for a period of time. Drip time is a function of product surface area and is determined to minimize fluid retention prior to packaging or freezing of the processed product.

The reduction of microbial flora on the treated products is believed to result from the impact of spray droplets and the oxidative properties of the antimicrobial component supplied by the spray apparatus, and from the synergistic interactions with microbial cells of the antimicrobial agent under pressure at reduced temperature in the pressure vessel. The reduced pH environment produced by the water solution used for spray washing and pressurizing the product encourages dissociation and protonation of macromolecules such as the phospholipids bilayers comprising the bacterial membranes resulting in a different local charge distribution, causing changing morphology, impaired cell division, changed adhesion, flocculation, and/or dissolution of the cytoplasmic membrane of the bacterium. It is believed that the high oxidation potential of the peroxygen component in the process water acting at elevated pressure greater than ambient atmospheric pressure results in enhanced reduction of microbial contaminants.

The unit portions of the food product may be packaged for distribution as fresh product by encapsulating the product within a layer of material that promotes oxygen transfer therethrough. This is preferable to hermetic sealing of the product that may promote anaerobic deterioration. Oxygen transfer through such wrapping material may be at a rate of about 0-10,000 cc/m²/24 hours at ambient atmospheric pressure and temperature of 70° F.

What is claimed is:

1. A method for processing animal source food products for retail distribution comprising:
spraying the unit portions with a water solution including an antimicrobial agent;
accumulating plural unit portions for exposure to a pressurized environment;
immersing the plural unit portions in a water solution including an antimicrobial agent under pressure above atmospheric level for a selected interval; and
after the selected interval, preparing the plural unit portions for distribution.

2. The method according to claim 1 in which the temperatures of the liquid water solutions are not greater than about 41° F.

3. The method according to claim 1 in which the liquid water solutions include a peroxygen compound in concentration within the range from about 50 to about 150 ppm.

4. The method according to claim 3 in which the peroxygen compound includes peracetic acid.

5. The method according to claim 1 in which a maximum pressure above atmospheric pressure does not exceed about 1300 psi.

6. The method according to claim 1 in which maximum pressure for selected animal source unit portions is within the range from about 420 to about 1300 psi.

7. The method according to claim 5 in which maximum pressure is established within a period of not greater than about 60 seconds.

8. The method according to claim 5 in which the maximum pressure is reduced to atmospheric level within a period of not greater than about 90 seconds.

9. The method according to claim 1 in which spraying includes impacting the unit portions with droplets of the water solution at effectively sufficient high velocity to reduce surface debris and to coat the unit portions.

10. The method according to claim 9 including a plural number of sprayings prior to accumulating plural unit portions.

11. The method according to claim 1 in which accumulating includes positioning each of plural unit portions into porous trays.

12. The method according to claim 11 in which a plural number of trays containing unit portions are assembled together for common spraying and pressurization above atmospheric level.

13. The method according to claim 8 including retaining maximum pressure for a period prior to reducing pressure not exceeding about 60 seconds.

14. The method according to claim 1 in which preparing the unit portions includes substantially drying surface areas of the unit portions in ambient air.

15. The method according to claim 14 in which preparing unit portions includes freezing.

16. The method according to claim 14 in which preparing the unit portions includes encapsulating the unit portions within a layer of material capable of transferring oxygen therethrough.

17. The method according to claim 16 in which the encapsulating within the layer of material promotes oxygen transfer therethrough at a rate of approximately 0-10,000 cc/m²/24 hr in ambient atmospheric pressure at a temperature of 70° F.
